(19) United States
(12) Patent Application Publication
(10) Pub. No.: US 2026/0005400 A1
(43) Pub. Date: Jan. 1, 2026

(54) ALL-SOLID-STATE BATTERY

(71) Applicants: Hyundai Motor Company, Seoul (KR); Kia Corporation, Seoul (KR)

(72) Inventors: Yoon Seon KIM, Hwaseong-si (KR); Hyun Geun KWON, Hwaseong-Si (KR); Jong Hwan CHOI, Hwaseong-Si (KR); Sung Ju CHO, Hwaseong-Si (KR)

(73) Assignees: Hyundai Motor Company, Seoul (KR); Kia Corporation, Seoul (KR)

(21) Appl. No.: 18/949,630

(22) Filed: Nov. 15, 2024

(30) Foreign Application Priority Data
Jun. 28, 2024 (KR) 10-2024-0085689

(51) Int. Cl. H01M 50/474; H01M 50/486

(52) U.S. Cl. CPC H01M 50/474; H01M 50/486; H01M 2300/0065

(57) ABSTRACT

An all-solid-state battery including a first electrode includes a first electrode collector, and a first electrode coating layer, a second electrode provided with a pole being different from that of the first electrode, stacked on the one side of the first electrode in the first direction, and including a second electrode collector, and a second electrode coating layer, a solid electrolyte provided between the first electrode and the second electrode, and an edge member extending to surround the second electrode coating layer, and including an opening hole, and a portion of the second electrode coating layer is formed to be inserted into the opening hole.

### CROSS-REFERENCE TO RELATED APPLICATION

The present application claims priority to Korean Patent Application No. 10-2024-0085689, filed on Jun. 28, 2024, the entire contents of which is incorporated herein for all purposes by this reference.

### BACKGROUND OF THE PRESENT DISCLOSURE

### Field of the Present Disclosure

The present disclosure relates to an all-solid-state battery.

### Description of Related Art

Unlike primary batteries that cannot be charged after discharging, secondary batteries which may be repeatedly charged and discharged may be applied to various fields, such as smartphones, vehicles, drones, and robots, and their importance is increasing day by day.

As a secondary battery according to a conventional technology utilizes a liquid as an electrolyte, a stability deteriorates, for example explosions and fires occur, when an expansion due to a temperature change or a leakage due to an external impact occurs, and researches and developments on all-solid-state batteries has been actively conducted to solve the present problem.

As the electrolyte positioned between the positive electrode coating layer and the negative electrode coating layer is made of solid, the all-solid-state battery may have a high structural stability, and thus a separator may not need to be provided. Accordingly, the battery may be miniaturized and the energy density may be further increased. However, in the case of an all-solid-state battery, there are limitations such as expansion and contraction of the electrode coating layer during charging/discharging, and accordingly, an interface between the electrode coating layer and the solid electrolyte is delaminated, and thus, performance deteriorates.

To the present end, a process of isostatically pressing the all-solid-state battery may be performed to prevent the interface between the electrode coating layer and the solid electrolyte from being delaminated, and the demand for a structure for preventing damage to an electrode tab of the electrode collector during a warm isostatic press process is increasing.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an all-solid-state battery which may prevent damage to an electrode tab during a warm isostatic press process.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an all-solid-state battery includes a first electrode including a first electrode collector, and a first electrode coating layer provided on one side of the first electrode collector in a first direction, a second electrode provided with a pole being different from a pole of the first electrode, stacked on one side of the first electrode in the first direction, and including a second electrode collector, and a second electrode coating layer provided on an opposite side of the second electrode collector in the first direction, a solid electrolyte provided between the first electrode and the second electrode, and an edge member stacked on the one side of the solid electrolyte in the first direction, extending to surround the second electrode coating layer, and including an opening hole formed on one side in a second direction crossing the first direction, and a portion of the second electrode coating layer is inserted into the opening hole.

The second electrode collector may include a second electrode body contacting with the second electrode coating layer, and inserted into the opening hole, and a second electrode tab protruding from the second electrode body to an one side of the second electrode body in the second direction.

The second electrode body may include a first body area surrounded by the edge member, and a second body area provided between the first body area and the second electrode tab to be inserted into the opening hole.

The second electrode coating layer may be formed in the first body area and the second body area.

A width of the second body area in a third direction crossing the first direction and the second direction may be smaller than a width of the first body area in the third direction.

The edge member may include a pair of first edge areas facing the second body area on one side of the first body area in the second direction, and a pair of second edge areas extending from the pair of first edge areas to an opposite side of the first body area in the second direction, and formed on opposite sides of the first body area in a third direction crossing the first direction and the second direction, and a third edge area extending to connect the pair of second edge areas on an opposite side of the first body area in the second direction.

The opening hole may be formed on the one side of the first body area between the pair of first edge areas.

When viewed in a state of being spaced apart in the first direction, an extent of the first electrode coating layer may be greater than an extent of the second electrode coating layer.

When viewed in a state of being spaced apart in the first direction, an extent of the first electrode coating layer may correspond to a sum of an extent of the second electrode coating layer and an extent of the edge member.

When viewed in a state of being spaced apart in the first direction, an extent of the first electrode coating layer may correspond to an extent of the solid electrolyte.

The edge member may be formed of a polymer film.

The first electrode may include a negative electrode, and the second electrode may include a positive electrode.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a vertical cross-sectional view of an all-solid-state battery according to an exemplary embodiment of the present disclosure;

FIG. 2 is a plan view of disassembled components of an all-solid-state battery according to an exemplary embodiment of the present disclosure;

FIG. 3 is a plan view of an edge member according to an exemplary embodiment of the present disclosure;

FIG. 4 is a plan view of a second electrode according to an exemplary embodiment of the present disclosure; and

FIG. 5 is a plan view exemplarily illustrating a state, in which a second electrode is inserted into an edge member, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms include the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in an exemplary embodiment of the present disclosure.

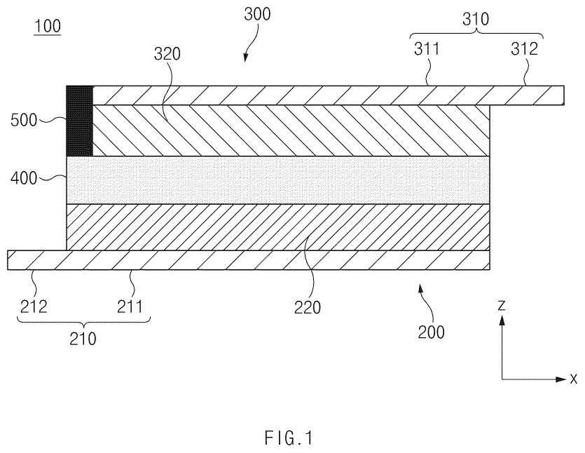

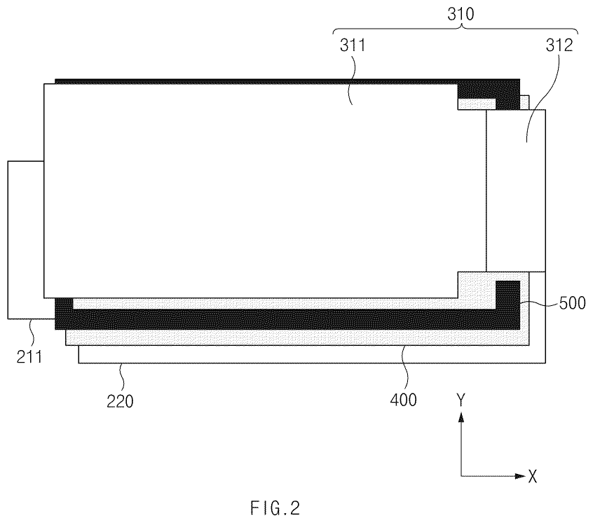

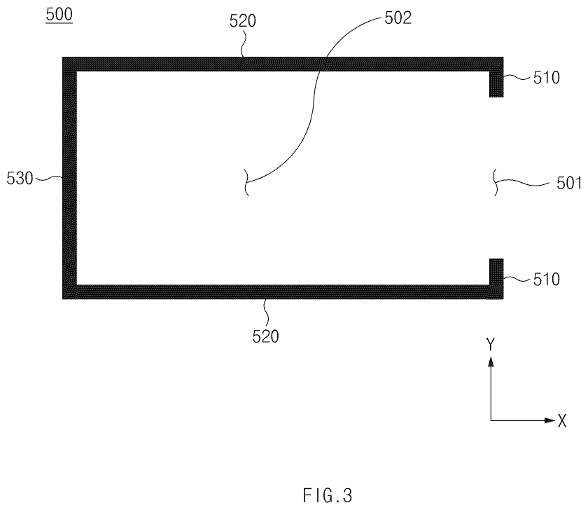

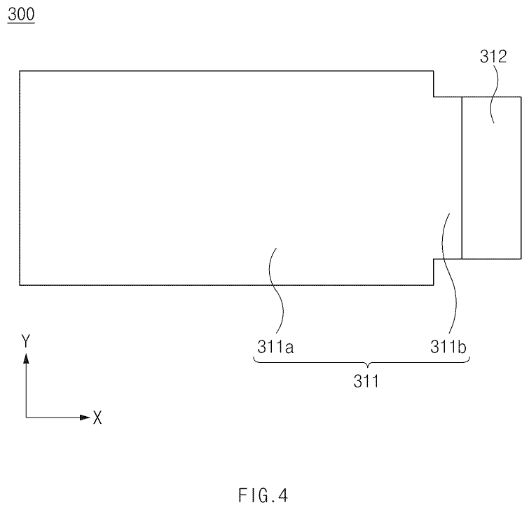

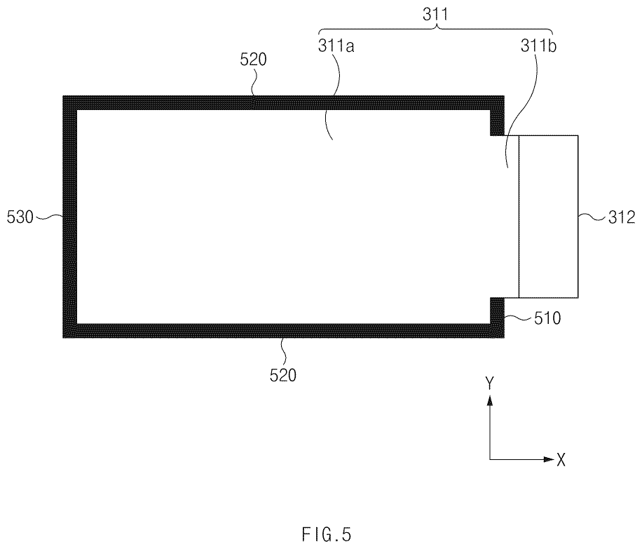

Hereinafter, various exemplary embodiments of the present disclosure will be described in detail with reference to FIG. 1, FIG. 2, FIG. 3, FIG. 4, and FIG. 5.

FIG. 1 is a vertical cross-sectional view of an all-solid-state battery according to an exemplary embodiment of the present disclosure. FIG. 2 is a plan view of disassembled components of an all-solid-state battery according to an exemplary embodiment of the present disclosure. FIG. 3 is a plan view of an edge member according to an exemplary embodiment of the present disclosure. FIG. 4 is a plan view of a second electrode according to an exemplary embodiment of the present disclosure. FIG. 5 is a plan view exemplarily illustrating a state, in which a second electrode is inserted into an edge member, according to an exemplary embodiment of the present disclosure.

Referring to FIG. 1, FIG. 2, FIG. 3, FIG. 4, and FIG. 5, an all-solid-state battery 100 may include a first electrode 200, a second electrode 300, and a solid electrolyte 400 which is provided between the first electrode 200 and the second electrode 300. The second electrode 300 may be stacked on one side (the “Z” direction) of the first electrode 200 in a first direction, and may be provided with a pole which is different from a pole of the first electrode 200. The first electrode 200 may be provided as a negative electrode, and the second electrode 300 may be provided as a positive electrode.

The first electrode 200 may include a first electrode collector 210 and a first electrode coating layer 220 which is provided on one side (the “Z” direction) of the first electrode collector 210 in the first direction. The second electrode 300 may include a second electrode collector 310 and a second electrode coating layer 320 which is formed on an opposite side (an opposite direction to the “Z” direction) of the second electrode collector 310 in the first direction.

The first electrode collector 210 may be formed of nickel (Ni) or may include nickel, but the present disclosure is not limited thereto. Furthermore, the second electrode collector 310 may be formed of aluminum (Al) or may include aluminum, but the present disclosure is not limited thereto.

The first electrode collector 210 may include a first electrode body 211, and a first electrode tab 212 that protrudes from the first electrode body 211. The second electrode collector 310 may include a second electrode body 311, and a second electrode tab 312 that protrudes from the second electrode body 311. The second electrode tab 312 may protrude from the second electrode body 311 to one side (the “X” direction) in the second direction, and the first electrode tab 212 may protrude from the first electrode body 211 in an opposite side (an opposite direction to the “X” direction) in the second direction.

The first electrode body 211 of the first electrode collector 210 may be a portion which is coated with the first electrode coating layer 220. The second electrode body 311 of the second electrode collector 310 may be a portion which is coated with the second electrode coating layer 320.

On the other hand, unlike a lithium ion battery, the all-solid-state battery 100 may include a solid electrolyte 400 in a solid state without a separate separator between the first electrode 200 and the second electrode 300. The all-solid-state battery 100 may be manufactured by coating or transferring the solid electrolyte 400 on one surface of the second electrode 300, which faces the first electrode 200.

Unlike a lithium ion battery, because the particles of the solid electrolyte 400 of the all-solid-state battery 100 are provided as solid-state particles, it is necessary to form an interface between the solid electrolyte 400 and the first electrode 200 or between the solid electrolyte 400 and the second electrode 300. To the present end, the all-solid-state battery 100 may require a warm isostatic press (WIP) process.

Meanwhile, when viewed in a state of being spaced apart in the first direction (the “Z” direction or an opposite direction to the “Z” direction), an extent of the first electrode coating layer 220 formed in the first electrode collector 210 may be greater than an extent of the second electrode coating layer 320 formed in the second electrode collector 310. This may be for preventing a short circuit between the first electrode 200 and the second electrode 300 from occurring when dendrites that are phenomena, in which lithium crystals are formed on a surface of the second electrode 300 and nuclei are stacked as the all-solid-state battery 100 is repeatedly charged and discharged.

To prevent this, an extent, by which the second electrode coating layer 320 is formed in the second electrode collector 310, may be smaller than an extent, by which the first electrode coating layer 220 is formed in the first electrode collector 210. In other words, the extent of the second electrode body 311 of the second electrode collector 310 may be smaller than the extent of the first electrode body 211 of the first electrode collector 210.

To compensate for a difference between the extent of the first electrode coating layer 220 and the extent of the second electrode coating layer 320, the all-solid-state battery 100 may include an edge member 500 that extends along a circumference of the second electrode 300.

When viewed in a state of being spaced apart in the first direction (the “Z” direction or an opposite direction to the “Z” direction), the extent of the first electrode coating layer 220 may correspond to a sum of the extent of the second electrode coating layer 320 and the extent of the edge member 500. Furthermore, when viewed in a state of being spaced apart in the first direction (the “Z” direction or an opposite direction to the “Z” direction), the extent of the first electrode coating layer 220 may correspond to the extent of the solid electrolyte 400.

One surface of the edge member 500 may be provided as an adhesive surface to be adhered to the second electrode collector 310 and the second electrode coating layer 320 outside the second electrode 300. The edge member 500 may be formed of a polymer film. As an exemplary embodiment of the present disclosure, the edge member 500 may be formed of polyethylene terephthalate (PET), but the present disclosure is not limited thereto.

Meanwhile, when a warm isostatic press process is performed on the all-solid-state battery 100, it is necessary to prevent damage to the second electrode tab 312 and the first electrode tab 212.

When the second electrode tab 312 contacts with the edge member 500 as the warm isostatic press process, is performed the second electrode tab 312 may be damaged, and the all-solid-state battery 100 according to an exemplary embodiment of the present disclosure may include a structure for preventing damage to the second electrode tab 312.

Referring to FIG. 3, the edge member 500 may be stacked on one side (the “Z” direction) of the solid electrolyte 400 in the first direction and extend to surround the second electrode coating layer 320, and may include an opening hole 501 which is formed on one side (the “X” direction) in the second direction. The opening hole 501 may be configured so that a portion of the second electrode coating layer 320 is inserted thereinto.

In more detail, the edge member 500 may include an opening hole 501 which is formed in a rectangular peripheral to surround the second electrode coating layer 320 and is formed on one side (the “X” direction) in the second direction.

The edge member 500 may form a second electrode insertion space 502 for accommodating the second electrode 300 therein, and the second electrode insertion space 502 may be provided on an opposite side (an opposite direction to the “X” direction) of the opening hole 501 in the second direction.

The edge member 500 may include first, second, and third edge areas 510, 520, and 530 that extend along a circumference of the second electrode insertion space 502.

A pair of first edge areas 510 may be formed on opposite sides of the opening hole 501 in the third direction (the “Y” direction or an opposite direction to the “Y” direction), respectively. The opening hole 501 may be formed between the pair of first edge areas 510.

A pair of second edge areas 520 may be provided, and may extend from the pair of first edge areas 510 on the opposite sides (an opposition direction to the “X” direction) in the second direction to be formed on opposite sides of the second electrode insertion space 502 in the third direction (the “Y” direction or an opposite direction to the “Y” direction).

The third edge area 530 may be formed on an opposite side (an opposite direction to the “X” direction) of the second electrode insertion space 502 in the second direction to extend to connect the pair of second edge areas 520. The third edge area 530 may extend parallel with the pair of first edge areas 510.

A portion of the second electrode collector 310 and the second electrode coating layer 320 may be inserted into the second electrode insertion space 502 defined in the present way. As illustrated in FIG. 4, the second electrode collector 310 may include a second electrode body 311 which is inserted into the second electrode insertion space 502 and the opening hole 501 while contacting with the second electrode coating layer 320, and a second electrode tab 312 that protrudes from the second electrode body 311 to one side (the “X” direction) in the second direction.

The second electrode body 311 may be a portion of the second electrode 300, to which the second electrode coating layer 320 is adhered, and the second electrode tab 312 may be another portion of the second electrode 300, which is not coated for electrical connection of the all-solid-state battery 100.

The second electrode body 311 may include a first body area 311a which is surrounded by the edge member 500 and is inserted into the second electrode insertion space 502, and a second body area 311b which is provided between the first body area 311a and the second electrode tab 312 and is inserted into the opening hole 501.

In the instant case, the second electrode coating layer 320 may be formed in the first body area 311a and the second body area 311b according to an exemplary embodiment of the present disclosure. Compared to a structure, in which the second electrode coating layer is formed only in the first body area, the second electrode 320 is formed on a wider area to form an interface of a wider area between the second electrode 300 and the solid electrolyte 400 of the all-solid-state battery 100.

Accordingly, a width of the second body area 311b in the third direction (the “Y” direction or an opposite direction to the “Y” direction) may be smaller than a width of the first body area 311a in the third direction. This may be for inserting the second body area 311b and the second electrode coating layer 320 adhered to the second body area 311b into the opening hole 501.

According to the present structure, because a portion of the second electrode coating layer 320 may be inserted into the opening hole 501, the second electrode coating layer 320 may support the second body area 311b. Accordingly, even when a warm isostatic press process is performed on the all-solid-state battery 100, damage to the second electrode tab 312 may be relatively decreased, and thus a productivity of the all-solid-state battery 100 may be improved.

Meanwhile, when the second electrode coating layer 320 and the second electrode collector 310 are inserted into the second electrode insertion space 502 as described above, an edge member 500 may be provided outside the first body area 311a, as illustrated in FIG. 5.

Accordingly, the pair of first edge areas 510 may be configured to face the second body area 311b on one side (the “X” direction) of the first body area 311a in the second direction.

The pair of second edge areas 520 may be disposed on opposite sides (the “Y” direction or an opposite direction to the “Y” direction) of the first body area 311a in the third direction to face the first body area 311a, respectively.

The third edge area 530 may be configured to face the first body area 311a on an opposite side (an opposite direction to the “X” direction) of the first body area 311a in the second direction.

According to the above-described structure, the all-solid-state battery 100 may include a structure, in which the second electrode coating layer 320 and the second body area 311b of the second electrode body 311 are inserted into the opening hole 501 of the edge member 500. Accordingly, a height deviation in the first direction between the second electrode tab 312 and the second electrode body 311 after a warm isostatic press process is applied to the all-solid-state battery 100 may be smaller than a height deviation in the first direction between the second electrode tab 312 and the second electrode body 311 stacked on one side of the edge member in the first direction, on which the edge hole is not formed.

Accordingly, even though a warm isostatic press is performed on the all-solid-state battery 100 according to an exemplary embodiment of the present disclosure, damage to the second electrode tab 312 may be prevented. Accordingly, a productivity of the all-solid-state battery 100 according to an exemplary embodiment of the present disclosure may be improved.

According to the technology, when a warm isostatic press process is performed on an all-solid-state battery, the positive electrode body of the current collector is inserted into the edge member, so that the productivity of the all-solid-state battery may be improved by preventing the positive electrode tab from being damaged by the edge member.

Furthermore, various effects directly or indirectly identified through the present specification may be provided.

The above description is a simple exemplary description of the technical spirits of the present disclosure, and an ordinary person in the art, to which the present disclosure pertains, may make various corrections and modifications without departing from the essential characteristics of the present disclosure.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An all-solid-state battery comprising:
a first electrode including a first electrode collector, and a first electrode coating layer provided on one side of the first electrode collector in a first direction;
a second electrode provided with a pole being different from a pole of the first electrode, stacked on the one side of the first electrode in the first direction, and including a second electrode collector, and a second electrode coating layer provided on an opposite side of the second electrode collector in the first direction;
a solid electrolyte provided between the first electrode and the second electrode; and
an edge member stacked on one side of the solid electrolyte in the first direction, extending to surround the second electrode coating layer, and including an opening hole formed on one side in a second direction crossing the first direction,
wherein a portion of the second electrode coating layer is inserted into the opening hole.

2. The all-solid-state battery of claim 1, wherein the second electrode collector includes:
a second electrode body contacting with the second electrode coating layer, and inserted into the opening hole; and
a second electrode tab protruding from the second electrode body to an one side of the second electrode body in the second direction.

3. The all-solid-state battery of claim 2, wherein the second electrode body includes:
a first body area surrounded by the edge member; and
a second body area provided between the first body area and the second electrode tab to be inserted into the opening hole.

4. The all-solid-state battery of claim 3, wherein the second electrode coating layer is formed in the first body area and the second body area.

5. The all-solid-state battery of claim 3, wherein a width of the second body area in a third direction crossing the first direction and the second direction is smaller than a width of the first body area in the third direction.

6. The all-solid-state battery of claim 3, wherein the edge member includes:
a pair of first edge areas facing the second body area on one side of the first body area in the second direction;
a pair of second edge areas extending from the pair of first edge areas to an opposite side of the first body area in the second direction, and formed on opposite sides of the first body area in a third direction crossing the first direction and the second direction; and
a third edge area extending to connect the pair of second edge areas on the opposite side of the first body area in the second direction.

7. The all-solid-state battery of claim 6, wherein the opening hole is formed on the one side of the first body area between the pair of first edge areas.

8. The all-solid-state battery of claim 1, wherein when viewed in a state of being spaced apart in the first direction, an extent of the first electrode coating layer is greater than an extent of the second electrode coating layer.

9. The all-solid-state battery of claim 1, wherein when viewed in a state of being spaced apart in the first direction, an extent of the first electrode coating layer corresponds to a sum of an extent of the second electrode coating layer and an extent of the edge member.

10. The all-solid-state battery of claim 1, wherein when viewed in a state of being spaced apart in the first direction, an extent of the first electrode coating layer corresponds to an extent of the solid electrolyte.

11. The all-solid-state battery of claim 1, wherein the edge member is formed of a polymer film.

12. The all-solid-state battery of claim 1,
wherein the first electrode includes a negative electrode, and
wherein the second electrode includes a positive electrode.
